(19) United States
(12) Patent Application Publication
(10) Pub. No.: US 2025/0307109 A1
(43) Pub. Date: Oct. 2, 2025

(54) SYSTEMS AND METHODS FOR GENERATING A RESOURCE ASSESSMENT METRIC USING ADVANCED COMPUTATIONAL MODELS FOR DATA ANALYSIS AND AUTOMATED PROCESSING

(71) Applicant: BANK OF AMERICA CORPORATION, Charlotte, NC (US)

(72) Inventors: Maharaj Mukherjee, Poughkeepsie, NY (US); George Anthony Albero, Charlotte, NC (US); Naga Vamsi Krishna Akkapeddi, Charlotte, NC (US); Lakshmi Narasimman, Chennai, Tamil Nadu (IN)

(73) Assignee: BANK OF AMERICA CORPORATION, Charlotte, NC (US)

(21) Appl. No.: 18/620,313

(22) Filed: Mar. 28, 2024

(51) Int. Cl. G06F 11/34; H04L 9/32

(52) U.S. Cl. CPC G06F 11/3452; H04L 9/3213

(57) ABSTRACT

Systems, computer program products, and methods are described herein for generating a resource assessment metric using advanced computational models for data analysis and automated processing. The present disclosure is configured to receive resource data, wherein the resource data comprises a resource token, geometric information, background information, and conditional information associated with a resource; receive device data, wherein the device data comprises geolocation data and gyroscopic data associated with a user device; determine an ownership chain of the resource, wherein determining the ownership chain comprises comparing the resource token with a resource token database; determine a user identification of a user associated with the resource by comparing a user token associated with the user with a user token database; and generate, using a generative AI module, an assessment metric associated with the resource, wherein generating the assessment metric comprises comparing the resource data and the device data with a resource database.

### TECHNOLOGICAL FIELD

Example embodiments of the present disclosure relate to generating a resource assessment metric using advanced computational models for data analysis and automated processing.

### BACKGROUND

There are significant challenges associated with determining assessment values of resources. Applicant has identified a number of deficiencies and problems associated with determining assessment values of resources. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for generating a resource assessment metric using advanced computational models for data analysis and automated processing.

Embodiments of the present invention address the above needs and/or achieve other advantages by providing apparatuses (e.g., a system, computer program product, and/or other devices) and methods for generating a resource assessment metric using advanced computational models for data analysis and automated processing. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present invention a system for generating a resource assessment metric using advanced computational models for data analysis and automated processing is provided. In some embodiments, the invention may receive resource data, wherein the resource data comprises a resource token, geometric information, background information, and conditional information associated with a resource. In some embodiments, the invention may receive device data, wherein the device data includes geolocation data and gyroscopic data associated with a user device. In some embodiments, the invention may determine an ownership chain of the resource, wherein determining the ownership chain includes comparing the resource token with a resource token database. In some embodiments, the invention may determine a user identification of a user associated with the resource by comparing a user token associated with the user with a user token database. In some embodiments, the invention may generate, using a generative artificial intelligence (AI) module, an assessment metric associated with the resource, wherein generating the assessment metric includes comparing the resource data and the device data with a resource database.

In some embodiments, the invention may transmit, to the generative AI module, resource functionality data, wherein the resource functionality data includes a resource functionality artifact representing the resource's functionality.

In some embodiments, the resource functionality data further includes using the geolocation data, the gyroscopic data, a microphone, and a camera associated with the user device to capture the resource functionality artifact.

In some embodiments, generating the assessment metric further includes determining, based on the resource functionality data, an appraisal value of the resource.

In some embodiments, determining the ownership chain further includes receiving, via the user device, at least two images of the resource token. In some embodiments, determining the ownership chain further includes creating a resource token model, wherein the resource token model includes a representation of the resource token including a seal associated with the resource token. In some embodiments, determining the ownership chain further includes determining the resource token is valid by comparing the resource token model with the resource token database.

In some embodiments, determining the user identification further includes receiving biometric information associated with the user. In some embodiments, determining the user identification further includes determining the biometric information is valid via a facial recognition module.

In some embodiments, the resource includes a vehicle.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for generating a resource assessment metric using advanced computational models for data analysis and automated processing, in accordance with an embodiment of the disclosure;

FIG. 2 illustrates a process flow for generating a resource assessment metric using advanced computational models for data analysis and automated processing, in accordance with an embodiment of the disclosure;

FIG. 3 illustrates an example embodiment of the invention, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. In some embodiments, a resource may be a vehicle, automobile, car, truck, or the like. When the resource comprises a vehicle, the vehicle may be for personal use, commercial use, industrial use, governmental use, or the like.

As used herein, a “transfer,” a “distribution,” and/or an “allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

In the realm of loan approval processes, financial institutions need to base approval conditions on assessment valuations of the resource to which the loan is attached. With regard to automotive loans, however, financial institutions often find difficulties in determining accurate assessment and/or appraisal values of the automobiles in question. Automobile dealers, such as large commercial dealers, have the tools and expertise at their disposal to make informed decisions about the value of a particular automobile. For example, a commercial automobile dealer may have a team of experts that provide informed decisions as to the quality and value of a vehicle. In this example, the experts may look at different areas of the vehicle, including but not limited to the trim level, engine capabilities, accident history, maintenance history, and the like. A problem arises during sales of automobiles wherein the seller or buyer does not have access to these types of tools and experts to assess the value of the vehicle.

When a vehicle transaction is made on the basis of an individual seller to an individual buyer, often times the buyer will need financing assistance to complete the purchase of the vehicle. A financial institution may step in to provide the financing to the buyer. However, the financial institution does not typically have the tools and experts to appraise the vehicle's value properly. Therefore, a need exists for a system to generate assessment values of the vehicles in order for the financial institution involved to provide adequate financing.

The system described herein may generate a resource assessment metric using advanced computational models for data analysis and automated processing. The system may receive data associated with a resource (e.g., a vehicle), which may include identification information (Vehicle Identification Number), background information (accident reports, maintenance reports, etc.), geometric information (vehicle measurements), conditional information (pictures of the vehicle), and mobility information (videos showing the vehicle running, stopping, engine noise, etc.). A user may use a user device (cell phone) to upload the information of the vehicle, along with information identifying the other party involved with the transaction. In this way, the user may upload the other party's photograph, license, passport, or the like to verify the identify of the other party. The system will determine a chain of ownership of the vehicle. Further, the system will generate an assessment metric, wherein the assessment metric includes an appraisal value of the vehicle.

What is more, the present disclosure provides a technical solution to a technical problem. As described herein, the technical problem includes determining appraisal values for resources. The technical solution presented herein allows for using generative AI to generate an assessment metric for a resource. In particular, the resource assessment generation system is an improvement over existing solutions to the determining appraisal values for resources, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the resource assessment generation system as described herein is a solution to the problem of appraisal value generation for resources (e.g., vehicles). Further, the resource assessment generation system may be characterized as identifying a specific improvement in computer capabilities and/or network functionalities in response to the resource assessment generation system's integration to existing devices, software, applications, and/or the like. In this way, the resource assessment generation system improves the capability of a system to generate assessment metrics (e.g., appraisal values) for a resource during a transaction. Further, the resource assessment generation system improves the functionality of networks in response to reducing the resources consumed by the system (e.g., network resources, computing resources, memory resources, and/or the like).

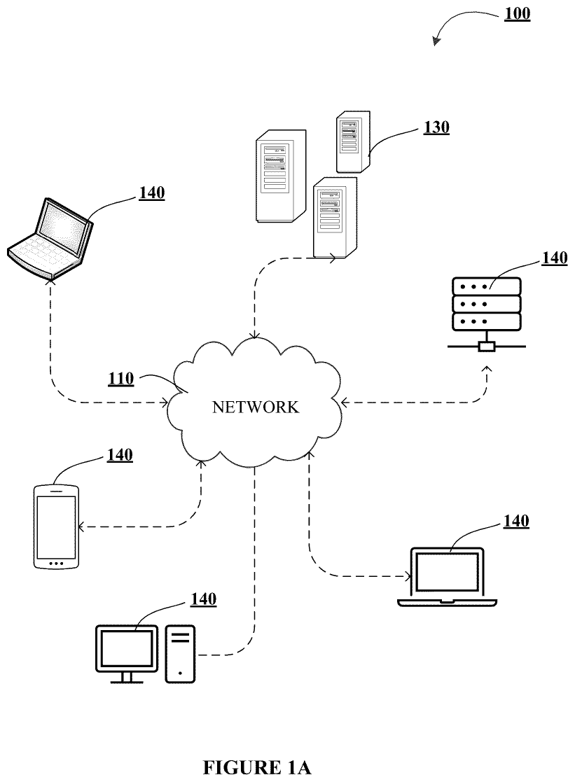

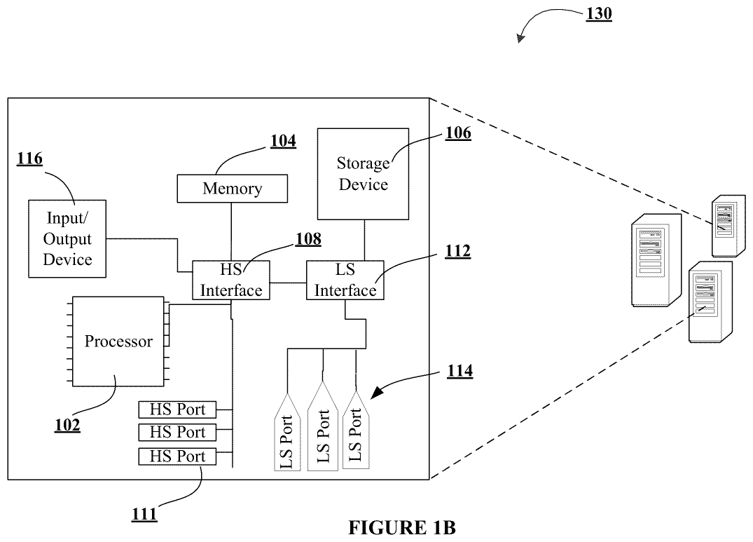

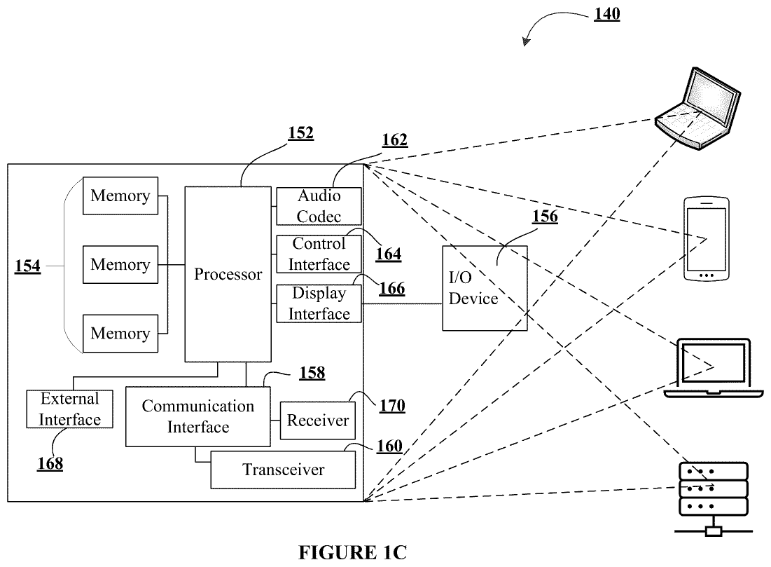

FIGS. 1A-1C illustrate technical components of an exemplary distributed computing environment 100 for generating a resource assessment metric using advanced computational models for data analysis and automated processing, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

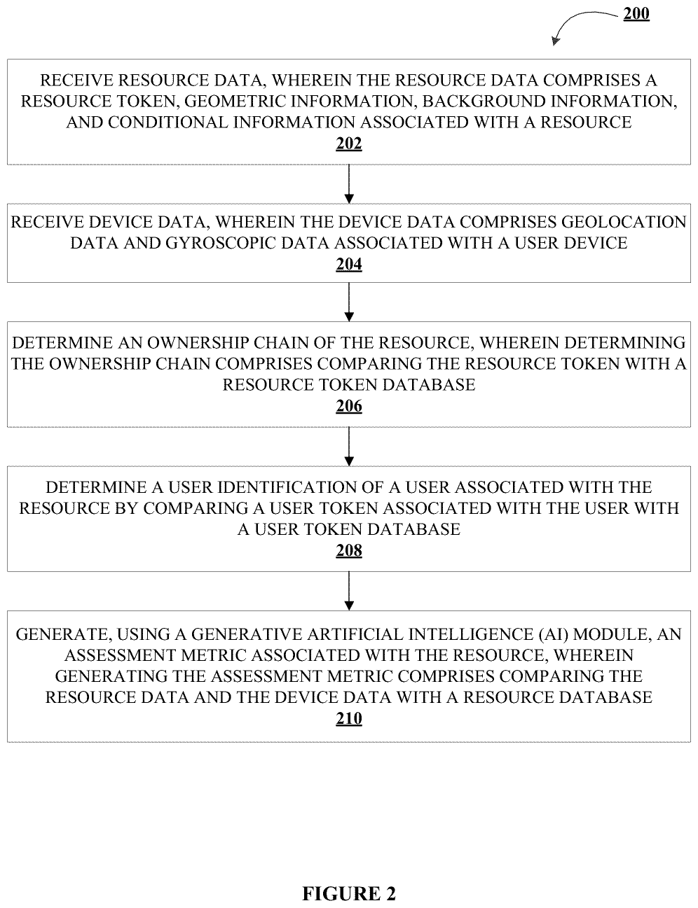

FIG. 2 illustrates a process flow for generating a resource assessment metric using advanced computational models for data analysis and automated processing, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a resource assessment generation system (e.g., similar to one or more of the systems described herein with respect to FIGS. 1A-1C) may perform one or more of the steps of process flow 200. For example, a resource assessment generation system (e.g., the system 130 described herein with respect to FIGS. 1A-1C) may perform the steps of process flow 200.

As shown in block 202 of FIG. 2, the process flow 200 of this embodiment includes receiving resource data, wherein the resource data includes a resource token, geometric information, background information, and conditional information associated with a resource.

In some embodiments, the resource may include a vehicle. The vehicle may be associated with a user. The user may be transacting with another individual to transfer the vehicle (e.g., resource), which may include selling, buying, or otherwise transferring the vehicle to the other individual. For example, the user may be associated with a vehicle and may be transacting with another individual to sell the user's vehicle.

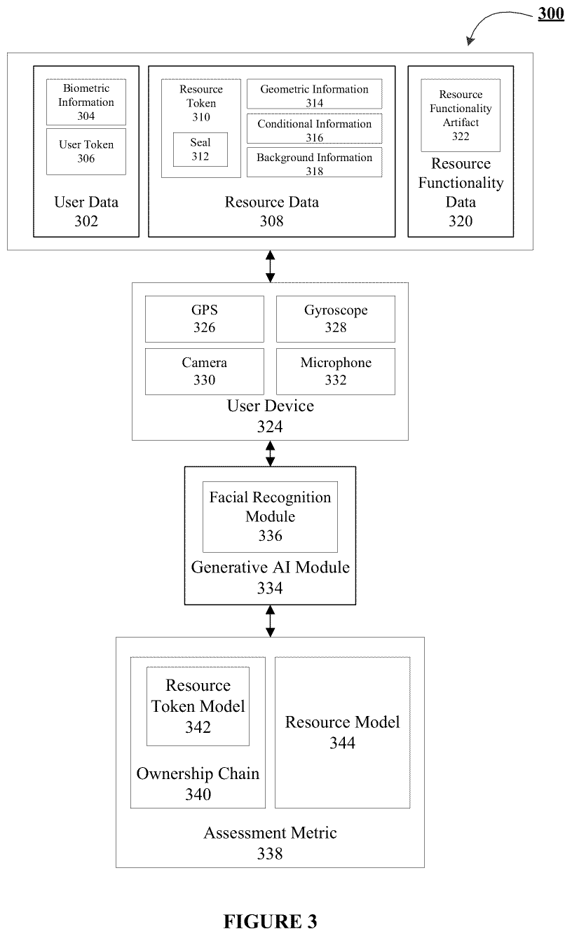

In some embodiments, the resource token may include a vehicle title associated with the vehicle. The vehicle title (e.g., resource token) may include identity information relating to the vehicle and the user associated with the vehicle. The vehicle title may be issued from an entity associated with a regulatory body, a governmental body, or the like, such as a department of motor vehicles. In this way, the vehicle title may include information identifying the vehicle through a public record database. For example, as shown in FIG. 3, the resource data 308 may include the resource token 310.

In some embodiments, the resource token may include other identifying information relating to the vehicle and the user, such as the vehicle title history, the license plate, the vehicle identification number (VIN), insurance documentation, the make and model of the vehicle, the production year of the vehicle, the color of the vehicle, or the like.

In some embodiments, the background information may include historical records associated with the resource. Historical records of the resource may include documentation explaining the history of the resource. In this way, the historical records may include accident reports, maintenance records, upgrades and/or downgrades to the resource, repair records, recall information, warranty information, registration history, emission test results, mileage records, or the like. The historical records may use privately available records (e.g., through upload to the system), publicly available records, or any combination thereof. For example, as shown in FIG. 3, the resource data 308 may include the background information 318.

In some embodiments, the geometric information may include physical measurements associated with the resource. The geometric information may be used to determine the vehicle (e.g., resource) conforms to the standards of the original equipment manufacturer (OEM). The physical measurements of the vehicle may include measurements of the exterior of the resource, such as the length, height, width, ground clearance, or the like. In this way, the geometric information may be used to determine alterations to the vehicle and the associated impact on an appraisal value of the vehicle by comparing the geometric information with a resource database, as will be described below. For example, as shown in FIG. 3, the resource data 308 may include the geometric information 314.

In some embodiments, the resource assessment generation system may create a resource model, wherein the resource model represents the resource in a digital format. The resource model may be a three-dimensional model of the resource that may be displayed on a user device. In this way, the system may use the resource model to instruct the user to gather more information about the vehicle. For example, as shown in FIG. 3, the resource assessment generation system may create the resource model 344 based on the geometric information 314 provided to the system. Further, in some embodiments, the resource model 344 may be created based on other information received such as the conditional information 316, background information 318, resource functionality data 320, or the like.

In some embodiments, the geometric information of the resource may be received from the user device. In this way, the user device's camera may be used to measure the resource's dimensions or send the images from the user device to the system to produce measurements based on the images. For example, as shown in FIG. 3, the user device 324 may gather the geometric information 314. In this example, the user device 324 may gather the geometric information 314 using the camera 330 of the user device 324.

In some embodiments, the geometric information of the resource may be inputted into the resource assessment generation system. For example, the user may measure the resource and manually input the measurements into the system to provide the geometric information of the resource. Further, in some embodiments, the user may list out which alterations to the vehicle the user made to provide the geometric information of the resource. For example, if the user has made an alteration to the vehicle that increases the ground clearance measurement of the vehicle, the user may input that information into the system. In this example, and as shown in FIG. 3, if the user updates the geometric information 314, the resource assessment generation system may update the resource model 344.

In some embodiments, and using the geometric information provided, the system may update the resource model to reflect the alterations, if any. The resource assessment generation system may accept, in real time, adjustments to the geometric information provided. In this way, if a user interacting with the resource assessment generation system decides a piece of information should be added, updated, deleted, or the like, the resource assessment generation system may accept the alteration and subsequently update the outputs provided by the system.

In some embodiments, the conditional information may include pictographic representations of the resource. The pictographic representations may include photos, videos, drawings, models, descriptions, or the like of the resource. The pictographic representations may be used to indicate the state (e.g., qualitative state) of the vehicle's interior and exterior, by way of representing any damage, or lack thereof, of the resource. For example, the conditional information may capture damage to the exterior of the vehicle, which may be used to adjust the valuation (e.g., appraisal) of the vehicle. Further, with reference to FIG. 3, the conditional information 316 may be included in the resource data 308.

In some embodiments, the resource assessment generation system may request additional information (e.g., geometric information, conditional information, or the like) from the user via the user device. For example, if the resource assessment generation system determines an image is out of focus, corrupted, doesn't show the vehicle properly, or is otherwise unusable, the resource assessment generation system may request the user upload a different image. Further, in some embodiments, the resource assessment generation system may use the resource model to instruct the user to gather more information (e.g., geometric information, conditional information, or the like) from the vehicle. For example, the resource assessment generation system may use the resource model to indicate that the user should take an image of the vehicle's engine for assessment. Further, with reference to FIG. 3, the generative AI module 334 may, after initially creating the resource model 344, request additional resource data 308, which may include use of the user device 324.

As shown in block 204 of FIG. 2, the process flow 200 of this embodiment includes receiving device data, wherein the device data includes geolocation data and gyroscopic data associated with a device.

The geolocation data may include the geolocation of the user device. In this way, the geolocation may include the real time geolocation of the user device. The gyroscopic data may include data that measures orientation and angular velocity. The gyroscopic data collected from the user device may help the resource assessment generation system determine how the user device is oriented and how it is moving. For example, as shown in FIG. 3, the user device 324 may include a GPS 326 (for the geolocation data) and a gyroscope 328 (for the gyroscopic data). In some embodiments, the device data may include accelerometer data. The accelerometer data may measure the user device's acceleration in any direction which may be used to determine the user device's motion, velocity, or the like.

Further, the device data (e.g., geolocation data, gyroscopic data, accelerometer data, or the like) may include a continuous stream of data gathered from the user device, and may include the speed, velocity, elevation, or the like, of the user device. For example, the geolocation data, gyroscopic data, and accelerometer data may indicate the user device's speed as it is traveling in the vehicle.

In some embodiments, the user device may gather resource functionality data, wherein the resource functionality data includes a resource functionality artifact representing the resource's functionality. In some embodiments, the resource functionality data may include the geolocation data, the gyroscopic data, or the accelerometer data. Further, in some embodiments, the resource functionality data may include using a microphone and a camera associated with the user device to capture the resource functionality data. For example, as shown in FIG. 3, the user device 324 may include a camera 330 and a microphone 332 to capture the resource functionality data.

The resource functionality data may represent the resource's functionality by showing how the vehicle (e.g., resource) idles, accelerates, maintains speed, turns, decelerates, brakes, or the like. The resource functionality artifact may include a picture, video, sound recording, or the like that shows the resource performing certain functions in certain conditions. For example, a sound recording (e.g., artifact) may record the sound of the vehicle's engine idling. In this example, the sound recording may indicate the performance of the vehicle's ignition sequence based on the sound recording. Further, as shown in FIG. 3, the resource functionality data 320 may include the resource functionality artifact 322.

As shown in block 206 of FIG. 2, the process flow 200 of this embodiment includes determining an ownership chain of the resource, wherein determining the ownership chain comprises comparing the resource token with a resource token database.

In some embodiments, determining the ownership chain may include receiving, via the user device, at least two images of the resource token. Further, in some embodiments, determining the ownership chain may include creating a resource token model, wherein the resource token model may include a representation of the resource token including a seal associated with the resource token. The seal associated with the resource token may be raised, lowered, protrude, or the like from the resource token as to create a three-dimensional raised image or design on the resource token. For example, the seal may be an embossed seal, a stamp, an embossed logo, or the like which may be used to authenticate the resource token. In this way, the at least two images taken from the user device may capture the three-dimensional image on the resource token. Further, the images of the resource token may then be used to create an accurate representation by way of the resource token model. The resource token model may represent the embossed seal because of the at least two images. For example, as shown in FIG. 3, the resource token 310 may include the seal 312.

Further, in some embodiments, determining the ownership chain may include determining the resource token is valid by comparing the resource token model with the resource token database. The resource token database may include a database operated by a resource token entity such as a regulatory entity, governmental entity, or the like. In this way, the resource token may be issued from the same resource token entity. Comparing the resource token associated with the resource and the resource token in the resource token database may include verifying that the resource token associated with the resource is the legitimate resource token as issued by the resource token entity. Comparing the resource tokens may include comparing the information on the resource tokens, comparing the seal of the resource token with the resource token database, or the like. For example, as shown in FIG. 3, the ownership chain 340 may include the resource token model 342.

As shown in block 208 of FIG. 2, the process flow 200 of this embodiment includes determining a user identification of a user associated with the resource by comparing a user token associated with the user with a user token database.

In some embodiments, determining the user identification may include receiving biometric information associated with the user. Further, in some embodiments, determining the user identification may include determining the biometric information is valid via a facial recognition module. The biometric information may include biometric features of a user. In this way, the biometric information of the user may be used in the facial recognition module to determine the user's identification. The biometric information may be captured via the user device and transmitted to the resource assessment generation system. For example, as shown in FIG. 3, the user data 302 may include the biometric information 304, which may be transmitted to the generative AI module 334.

In some embodiments, the user token may include a driver's license associated with the user. In some embodiments, the user token may include any other piece of information used to identify the user, such as a passport, social security card, taxpayer identification number, date of birth, or the like. The user token database may be associated with a user token entity that stores the user token, such as a department of motor vehicles, government entity, regulatory entity, or the like. For example, as shown in FIG. 3, the user data 302 may include the user token 306.

Comparing the user token associated with a user and the user token database may include comparing the information associated with the user token with the information stored in the user token database. For example, the name, address, date of birth, identification number, or the like may be used to compare with the user token database. Further, a device camera may be used to capture the user token to be used by the resource assessment generation system to compare against the resource token database.

In some embodiments, determining the user identification may include analyzing, using a facial recognition module and a device camera of the device, the user. In some embodiments, determining the user identification may include determining a match between the facial recognition analysis of the user and the user token. For example, as shown in FIG. 3, the user data 302 (including the biometric information 304 and/or the user token 306) may be captured with the camera 330 of the user device 324 and analyzed by the generative AI module 334 with the facial recognition module 336.

As shown in block 210 of FIG. 2, the process flow 200 of this embodiment includes generating, using a generative artificial intelligence (AI) module, an assessment metric associated with the resource, wherein generating the assessment metric includes comparing the resource data and the device data with a resource database.

The generative AI module may include natural language processing (NLP), machine learning, computer vision, reinforcement learning, and the like, in order to generative the assessment metric. Further, the generative AI module may include sentiment analysis, semantic analysis, data analysis, geolocation analysis, and the like.

In some embodiments, the resource assessment generation system may include transmitting, to the generative AI module, resource functionality data, wherein the resource functionality data includes a resource functionality artifact representing the resource's functionality. The resource functionality data may represent the resource's ability to function in certain conditions. For example, the resource functionality data may include the vehicle idling, accelerating, maintaining speed, turning, decelerating, braking, stopping, changing gears, or any combination thereof.

In some embodiments, the resource functionality artifact may include a picture, video, sound recording, or the like, that may capture the resource's functionality data. For example, a video (e.g., the resource functionality artifact 322 in FIG. 3) may capture the vehicle accelerating to a predetermined speed. The generative AI module may then use the resource functionality data capture via the artifact to determine how well the resource functions. In this way, the system may compare the resource functionality data with a resource database, wherein the resource database includes OEM specified functionality statistics of a given resource. For example, the system may compare a vehicle's resource functionality data with specifications published by the OEM of the vehicle. In this way, the system may determine how well the vehicle functions according to a baseline (e.g., the OEM specifications in the resource database).

In some embodiments, the resource functionality data may include using the geolocation data, the gyroscopic data, a microphone, and a camera associated with the user device to capture the resource functionality artifact. Using the geolocation data, gyroscopic data, a microphone, and a camera provides the system with insight as to how the vehicle is functionally performing during a given task. For example, a video (e.g., the resource functionality artifact 322 captured using the microphone 332 and camera 330, as shown in FIG. 3) may be used to determine how well the vehicle's engine functions during an ignition sequence. The generative AI module may use the data from the microphone and camera to determine the vehicle's ignition sequence is acceptable. Further, the resource assessment generation system may compare the resource's functionality in the video against an OEM's specifications that define a proper ignition sequence of the vehicle.

In some embodiments, the resource assessment generation system may request the user upload particular resource functionality data. The resource assessment generation may have certain benchmarks used to determine an assessment value of the resource. For example, the resource assessment generation system may require the user upload a video, from within the vehicle, of the vehicle accelerating up to, and driving at, a given speed. Further, the resource assessment generation system may require the vehicle's speedometer be within the video frame during recording. In this example, the resource assessment generation system may use the video to determine whether a discrepancy exists between the vehicle's speedometer and the actual speed of the vehicle, as compared with the geolocation data of the user device. Further, the microphone may be used to determine how well the vehicle's engine functions during acceleration, and may be compared against the resource database (which may include a database of vehicle engine sounds during acceleration). Further still, gyroscopic data captured during the recording of the artifact may be used to determine the quality of the suspension of the vehicle and, similarly, may be compared against a resource database containing similar data for comparison.

In some embodiments, the resource assessment generation system may, in real time, request the user to drive the vehicle in certain ways. In this way, the resource assessment generation system may, in real time, analyze the functionality of the vehicle. Further, the resource assessment generation system may, in real time, update the instructions to the user while the user is driving. For example, the resource assessment generation system may request the user to take a turn in the vehicle to analyze the functionality of the vehicle's suspension while turning. In this example, the resource assessment generation system may analyze the device data (e.g., geolocation data, gyroscopic data, or the like) while the vehicle is turning. In this way, and as shown in FIG. 3, the generative AI module 334 may send requests to the user device 324 to capture certain resource data 308 or resource functionality data 320.

In some embodiments, generating the assessment metric may include determining, based on the resource functionality data, an appraisal value of the resource. The appraisal value of the vehicle may be based on the resource data, resource functionality data, device data, or the like. In this way, the appraisal value may include a monetary value associated with the value of the vehicle. Further, the appraisal value may take into account the location (e.g., geolocation) of the vehicle to consider a local market impact. In this way, the local market may include a regional market, national market, global market, or any size market. Further, the appraisal value may take into account seasonality adjustments for the vehicle's monetary value.

For example, as shown in FIG. 3, the generative AI module 334 may generate the assessment metric 338. In this way, the assessment metric 338 may include information about the resource (e.g., the ownership chain 340, the resource token model 342, and the resource model 344) and base the appraisal value on the information the generative AI module 334 has collected from the user device 324. The assessment metric 338 may display the resource model 344 and show areas (e.g., geometric information 314, conditional information 316, resource functionality data 320, or the like) that may be affecting the appraisal value of the resource. For instance, if a vehicle has a damaged engine, the assessment metric 338 may display the resource model 344 as having a damaged engine and show the impact on the appraisal value of the vehicle. Similarly, the ownership chain 340 and resource token model 342 may be displayed in conjunction with the assessment metric 338 as to indicate the vehicle's ownership history.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for generating a resource assessment metric using advanced computational models for data analysis and automated processing, the system comprising:
a processing device;
a non-transitory storage device containing instructions when executed by the processing device, causes the processing device to perform the steps of:
receive resource data, wherein the resource data comprises a resource token, geometric information, background information, and conditional information associated with a resource;
receive device data, wherein the device data comprises geolocation data and gyroscopic data associated with a user device;
determine an ownership chain of the resource, wherein determining the ownership chain comprises comparing the resource token with a resource token database;
determine a user identification of a user associated with the resource by comparing a user token associated with the user with a user token database; and
generate, using a generative artificial intelligence (AI) module, an assessment metric associated with the resource, wherein generating the assessment metric comprises comparing the resource data and the device data with a resource database.

2. The system of claim 1, wherein executing the instructions further causes the processing device to transmit, to the generative AI module, resource functionality data, wherein the resource functionality data comprises a resource functionality artifact representing the resource's functionality.

3. The system of claim 2, wherein the resource functionality data further comprises using the geolocation data, the gyroscopic data, a microphone, and a camera associated with the user device to capture the resource functionality artifact.

4. The system of claim 1, wherein generating the assessment metric further comprises determining, based on the resource functionality data, an appraisal value of the resource.

5. The system of claim 1, wherein determining the ownership chain further comprises:
receiving, via the user device, at least two images of the resource token;
creating a resource token model, wherein the resource token model comprises a representation of the resource token including a seal associated with the resource token; and
determining the resource token is valid by comparing the resource token model with the resource token database.

6. The system of claim 1, wherein determining the user identification further comprises:
receiving biometric information associated with the user; and
determining the biometric information is valid via a facial recognition module.

7. The system of claim 1, wherein the resource comprises a vehicle.

8. A computer program product for generating a resource assessment metric using advanced computational models for data analysis and automated processing, the computer program product comprising a non-transitory computer-readable medium comprising code causing an apparatus to:
receive resource data, wherein the resource data comprises a resource token, geometric information, background information, and conditional information associated with a resource;
receive device data, wherein the device data comprises geolocation data and gyroscopic data associated with a user device;
determine an ownership chain of the resource, wherein determining the ownership chain comprises comparing the resource token with a resource token database;
determine a user identification of a user associated with the resource by comparing a user token associated with the user with a user token database; and
generate, using a generative artificial intelligence (AI) module, an assessment metric associated with the resource, wherein generating the assessment metric comprises comparing the resource data and the device data with a resource database.

9. The computer program product of claim 8, wherein the code further causes the apparatus to transmit, to the generative AI module, resource functionality data, wherein the resource functionality data comprises a resource functionality artifact representing the resource's functionality.

10. The computer program product of claim 9, wherein the resource functionality data further comprises using the geolocation data, the gyroscopic data, a microphone, and a camera associated with the user device to capture the resource functionality artifact.

11. The computer program product of claim 8, wherein generating the assessment metric further comprises determining, based on the resource functionality data, an appraisal value of the resource.

12. The computer program product of claim 8, wherein determining the ownership chain further comprises:
receiving, via the user device, at least two images of the resource token;
creating a resource token model, wherein the resource token model comprises a representation of the resource token including a seal associated with the resource token; and
determining the resource token is valid by comparing the resource token model with the resource token database.

13. The computer program product of claim 8, wherein determining the user identification further comprises:
receiving biometric information associated with the user; and
determining the biometric information is valid via a facial recognition module.

14. The computer program product of claim 8, wherein the resource comprises a vehicle.

15. A method for generating a resource assessment metric using advanced computational models for data analysis and automated processing, the method comprising:
receiving resource data, wherein the resource data comprises a resource token, geometric information, background information, and conditional information associated with a resource;
receiving device data, wherein the device data comprises geolocation data and gyroscopic data associated with a user device;
determining an ownership chain of the resource, wherein determining the ownership chain comprises comparing the resource token with a resource token database;
determining a user identification of a user associated with the resource by comparing a user token associated with the user with a user token database; and
generating, using a generative artificial intelligence (AI) module, an assessment metric associated with the resource, wherein generating the assessment metric comprises comparing the resource data and the device data with a resource database.

16. The method of claim 15, wherein the method further comprises transmitting, to the generative AI module, resource functionality data, wherein the resource functionality data comprises a resource functionality artifact representing the resource's functionality.

17. The method of claim 16, wherein the resource functionality data further comprises using the geolocation data, the gyroscopic data, a microphone, and a camera associated with the user device to capture the resource functionality artifact.

18. The method of claim 15, wherein generating the assessment metric further comprises determining, based on the resource functionality data, an appraisal value of the resource.

19. The method of claim 15, wherein determining the ownership chain further comprises:
receiving, via the user device, at least two images of the resource token;
creating a resource token model, wherein the resource token model comprises a representation of the resource token including a seal associated with the resource token; and
determining the resource token is valid by comparing the resource token model with the resource token database.

20. The method of claim 15, wherein determining the user identification further comprises:
receiving biometric information associated with the user; and
determining the biometric information is valid via a facial recognition module.
